(19) United States
(12) Patent Application Publication
(10) Pub. No.: US 2011/0146621 A1
(43) Pub. Date: Jun. 23, 2011

(54) Fire Truck Idle Reduction System

(76) Inventors: Bradley Weisz, Tea, SD (US); Scott Oyen, Crooks, SD (US)

(21) Appl. No.: 12/641,190

(22) Filed: Dec. 17, 2009

(51) Int. Cl. F02D 41/00; H02P 9/04; B60L 1/00; H02J 7/32

(52) U.S. Cl. 123/339.18; 290/51; 307/9.1; 320/138

(57) ABSTRACT

A fire truck or rescue vehicle idle reduction system, including: a fire truck or rescue vehicle; an engine in the fire truck or rescue vehicle; a battery in the fire truck or rescue vehicle; an alternator connected to the engine for changing the battery; a generator in the fire truck or rescue vehicle; an alternator connected to the generator for charging the battery; a ventilation system in the fire truck or rescue vehicle, the ventilation system being powered by the battery; a lighting system in the fire truck or rescue vehicle, the lighting system being powered by the battery; a parking brake system in the rescue vehicle; a system for determining whether the parking brake is engaged; and a system for shutting off the engine and starting the generator when the parking brake is engaged.

### TECHNICAL FIELD

The present invention relates to fire truck and rescue vehicle engines and power systems.

### BACKGROUND OF THE INVENTION

Fire trucks consume a significant amount of gasoline or diesel fuel. As a result, they are both expensive to operate, and they produce an undesirably high amount of emissions. Also, fire trucks typically spent a significant amount of time sitting and idling on many of their emergency calls. This excessive idling is due to the following factors.

Nationally, about 90% of fire truck runs do not involve a fire. This is due to the fact that about 80% of runs are for emergency medical services calls, and about 10% are false alarms. In situations where fires are involved, the truck engine must be running to operate the water pumping system. In addition, however, power is also required to operate the various lighting systems and ventilation systems on the truck. Fire trucks also typically have plug in outlets on their sides to power plug in tools, equipment and remote lighting systems. As a result, the typical fire truck engine is simply kept running at all times when the fire truck is at the scene of an emergency call. As can therefore be appreciated, fire trucks spend a lot of time idling. This burns up a lot of fuel. Also, too much idle time can result in clogged diesel particulate engine filters which are expensive to service.

What is instead desired is a system to reduce the amount of time that a fire truck is spent sitting and idling, especially when it is not operating its water pumping system (which requires considerable power from the engine to operate). It is instead desirable to provide a system that shuts down an idling engine, yet has safety features such that the fire truck's battery charge is not simply depleted by the operation of the fire truck's lights (and/or its heating and cooling systems).

### SUMMARY OF THE INVENTION

The present invention provides a system for automatically shutting down an idling fire truck's engine, while ensuring that the truck's lighting, ventilation and electrical systems can still be operated without the danger of depleting the truck's battery.

In preferred aspects, the present invention provides a fire truck engine idle reduction system, comprising: a fire truck having an engine; a battery; an alternator connected to the engine for charging the battery; an onboard generator; an alternator connected to the generator for charging the battery; a water pumping system; a ventilation system powered by the battery; a lighting system powered by the battery; a parking brake; a system for determining whether the water pumping system is in pump mode; a system for determining whether the parking brake is engaged. Also included is a system for shutting down the engine and starting the onboard generator when the water pumping system is not in pump mode and the parking brake is engaged. Preferably, the parking brake must be engaged for a pre-determined period of time before the system for shutting off the engine and starting the generator actually shuts off the engine and starts the generator.

In another aspect, the present invention provides a method of reducing fire truck engine idling, by: operating a fire truck with an idle reduction system configured to: (a) determine if a water pumping system on the fire truck is in pump mode; (b) determine if the parking brake on the fire truck is engaged; and then (c) shut off the engine and start an on board generator to charge the fire truck battery when the water pumping system is not in pump mode and the parking brake is engaged.

In optional preferred aspects, the present invention further comprises: a battery monitoring safety system for determining the strength of the battery; and a system for restarting the engine to charge the battery if the strength of the battery drops below a pre-determined level. The battery monitoring system may be a voltage meter that is part of a programmable logic control system.

It is to be understood that the present invention is not limited to fire trucks. Rather, it may be used with other rescue vehicles including ambulances, paramedic rescue vehicles and other vehicles lacking a water pumping system. In these instances, the present invention provides a rescue vehicle idle reduction system, comprising: a rescue vehicle having an engine; a battery; an alternator connected to the engine for changing the battery; an onboard generator in the rescue vehicle; an alternator connected to the generator for charging the battery; an optional ventilation system powered by the battery; an optional lighting system powered by the battery; a parking brake system; a system for determining whether the parking brake is engaged; and a system for shutting off the engine and starting the on board generator when the parking brake has been engaged.

The advantages of the present invention may include: (1) monetary savings by reduced fuel consumption; (2) reduced vehicle emissions; (3) very little additional cost per vehicle to install the present system; and (4) a longer life for the engine's diesel particulate filters. As a result of these “green” advantages, many local, state, and federal grants and programs will help to pay for this idle reduction technology.

### BRIEF DESCRIPTION OF THE DRAWINGS

FIG. 1 is a schematic perspective view of the placement of the components of the present system in operation in a fire truck.

FIG. 2 is a schematic perspective view of the placement of the components of the present system in operation in a rescue vehicle

### DETAILED DESCRIPTION OF THE DRAWINGS

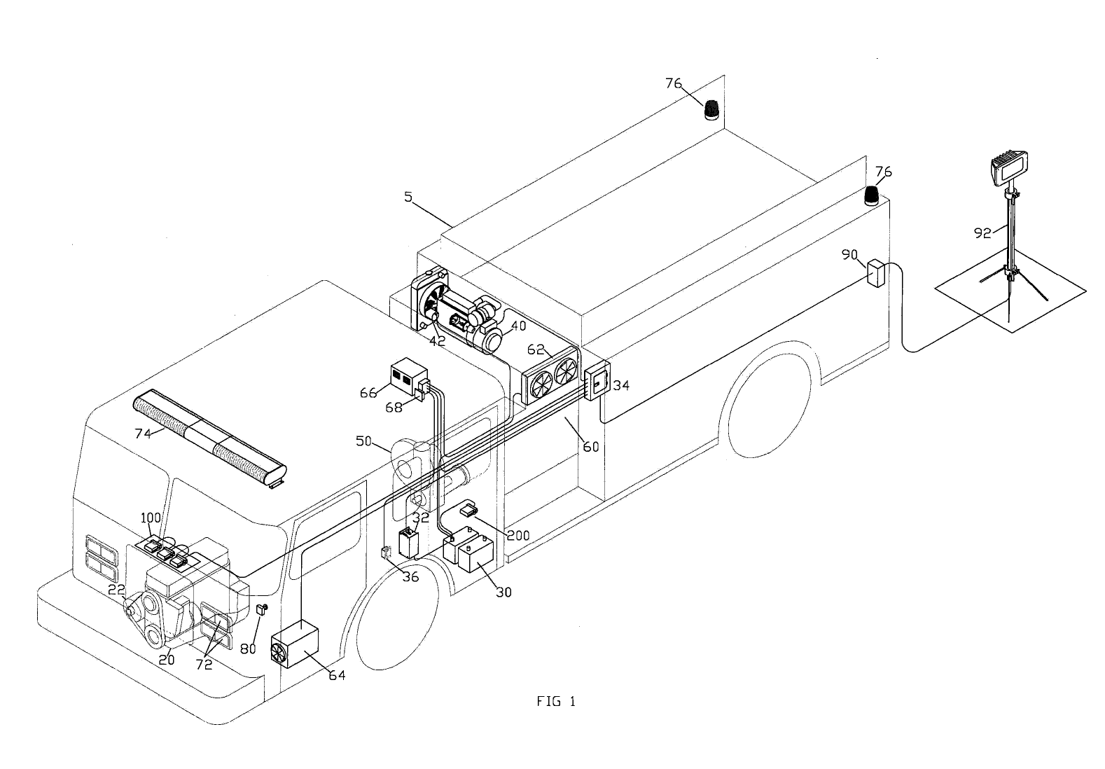

Referring first to FIG. 1, the present idle reduction system involves a variety of components placed at various locations around a fire truck, as follows.

A fire truck 5 is fitted with an idle reduction system 10. Idle reduction system 10 preferably comprises an engine 20, a battery 30; and a first alternator 22 connected to engine 20 for charging battery 30. System 10 also comprises an onboard generator 40, with a second alternator 42 for charging battery 30. A water pumping system 50 is also provided. As is typical of fire trucks, water pumping system 50 requires significant power and is powered by engine 20. (As such, the fire truck pumps water when its engine 20 is turned on. This design is typical of all standard fire trucks.) A ventilation system 60 is also provided. Ventilation system 60 can be used to heat (and/or cool) the truck cab. Ventilation system 60 is powered by battery 30. A lighting system 70 is also provided. As is well known, fire trucks have numerous lights which are operated both as the truck rushes through traffic and when the truck is stopped at the scene of an emergency. Therefore, lighting system 70 operates to run both flashing headlights and flashing top/side lights, as well as interior cab lights on the truck. Lighting system 70 is also powered by battery 30. Fire truck 5 also has a standard parking brake system 80.

In accordance with the present invention, the idle reduction system includes logic circuit systems 100 for: (a) determining whether the water pumping system 50 is in its “pump mode” (i.e.: the system is actively turned on to pump water or is pumping water); and (b) determining whether parking brake 80 is engaged. Once these two systems have determined that both the water pumping system 50 is not in its “pump mode” and that parking brake 80 is engaged, then a third system (c) is provided to shut off engine 20 and start generator 40.

As a result, system 10 automatically turns off engine 20 and starts on board generator 40 when the water pumping system 50 is not pumping and the parking brake 80 is engaged. When parking brake 80 is engaged for a pre-determined period of time, the system for shutting off the engine and starting the generator shuts off the engine and starts the generator. If the time period is too short, the engine may shut off too soon after arriving at the scene of the call, and may need to be quickly restarted. Conversely, if the time period it too long, the truck will simply burn up more fuel before being turned off. In preferred embodiments, the pre-determined period of time before system 10 turns off engine 20 and starts generator 40 is typically about five minutes.

System 10 is therefore very advantageous in that (when turned on) it operates automatically. Therefore, when firefighters arrive on a scene they can park their vehicle and respond to the emergency. If the situation is not a fire, then the pumping system 50 is never set into its active “pump mode”. The firefighters simply leave the cab of the vehicle and attend to the emergency. After the predetermined period of time, system 10 will then automatically turn off engine 20 and activate onboard generator 40. The result is that generator 40 keeps the truck's batteries 30 charged. Thus, batteries 30 can keep lighting system 70 and ventilation system 60 operating. In addition, generator 40 can also provide power to any of the plug in electrical components (e.g.: flood lamp 92) plugged into one of the electrical outlets 90 on the exterior surface of the fire truck.

It is of course important to make sure that battery 30 does not become depleted when engine 20 is off and ventilation system 60, lighting system 70 and electrical outlets 90 are all in use. Therefore, in optional preferred embodiments, a safety system 200 is included, as follows. Safety system 200 (which may be a component of system 100) includes both: (a) a battery monitoring system for determining the strength of battery 30; and (b) a system for restarting engine 20 to charge battery 30 if the strength of battery 30 drops below a pre-determined level.

The applicants have constructed and operated an embodiment of the present invention. Further details of the particular components used are described below. However, it is to be appreciated these descriptions are merely exemplary and that the present invention is not limited to these specific components.

Fire truck 5 was a pumper system as made by Rosenbauer Firefighting Technology (or Central States Fire) of Lyons, S. Dak. Engine 20 was a Detroit Diesel made by Detroit Diesel corporation. Battery 30 was a standard automotive battery. On board generator 40 was a Tier 4 Kubota diesel 1800 rpm engine and Pancake Generator made by Marathon corporation. When powering lighting system 70 and ventilation system 60 and maintaining the charge in battery 30, onboard generator 40 consumes approximately 1.25 liters of fuel/hr.

The electrical system can also comprise a battery charger 32, shoreline connection 36 and a circuit breaker 34. Shoreline connection 36 is an outlet into which the fire truck is plugged when it is sitting in the fire house. The shoreline connection 36 ensures that the battery 30 remains fully charged, and maintains the chassis temperature by powering compressor and condenser 64 when the truck is sitting in the firehouse. Circuit breaker 34 directs the shoreline power to the battery charger 32, which then charges battery 30 and directs power from generator 40 to battery charger 32 which charges battery 30. Thus, the shoreline power cable can be used to power the ventilation 60 system when the fire truck is in the station. Shoreline plug battery charger 32 was a NewMar battery charger that is capable of a continuous 40 AMP (or optional 80 AMP) charge. This battery charger 32 maintains the batteries at peak charge when running on shoreline power.

The NewMar shoreline receptacle is rated for 20 AMPS at 120V. It helps maintain the interior temperature of the cab by operating ventilation system 60 on a low output setting. This keeps the interior cool and free from excess moisture. The shoreline plug also has an auto-eject feature that unplugs the cable from the receptacle when the chassis ignition button is depressed, ensuring the fire truck leaves the firehouse without dragging a power cord. The workload of the shoreline receptacle is taken over by onboard generator 40 when the vehicle is in the idle reduction mode.

Pumping system 50 was a waterous CSUCIOC single stage 1,500 gallon/min single stage pump. Ventilation system 60 included a compressor and condenser 62 for maintaining cabin environment when in idle reduction mode and not plugged into shoreline power, and an air conditioning compressor and condenser 64 for maintaining cabin environment when the station and shoreline power is connected. Also included was a air conditioning and heating unit 66, having a controlling thermostat 68; and an air conditioning compressor 69 (driven by onboard generator 40). Ventilation system 60 provided 650CFM of air flow and 32,000 BTU of thermostatically controlled cooling power in a 12VDC system. Lighting system 70 includes front lights 72, top lights 74, and top rear lights 76. Other lights (including interior cabin lights) are included as well.

Idle reduction system 10 is controlled by programmable controllers 100 in the cab of the fire truck. Battery monitoring safety system 200 can comprise logic circuits that are housed near battery 30. The engine re-starts when the battery voltage drops to less than or equal to 12.2VDC.

The advantage of using onboard generator 40 is that it consumes so much less fuel than engine 10. Engine 10 and generator 20 share a main fuel reservoir; however, the present invention also covers alternate truck and rescue vehicle designs wherein the engine and generator do not share the same fuel reservoir.

Therefore, the present invention also includes a method of reducing fire truck engine idling, by: operating a fire truck with an idle reduction system configured to: (a) determine if a water pumping system on the fire truck is in pump mode; (b) determine if the parking brake on the fire truck is engaged; and then (c) shut off the engine after a pre-determined amount of time has elapsed and start an on board generator to charge the fire truck battery when the water pumping system is not in pump mode and the parking brake is engaged.

Optionally, this method further comprises: monitoring the strength of the battery; and restarting the engine to charge the battery if the strength of the battery drops below a pre-determined level.

As was stated above, the present invention is not limited to fire trucks. Rather, it is equally well suited to applications that do not pump water (including ambulances and paramedic rescue vehicles). In such applications, the only real difference is that the idle reduction system does not have to determine whether the vehicle is in “pump mode”. Instead, all that is required is a system 100 that will (a) determine whether the parking brake is engaged; and (b) shut off the engine and start the generator when the parking brake has been engaged.

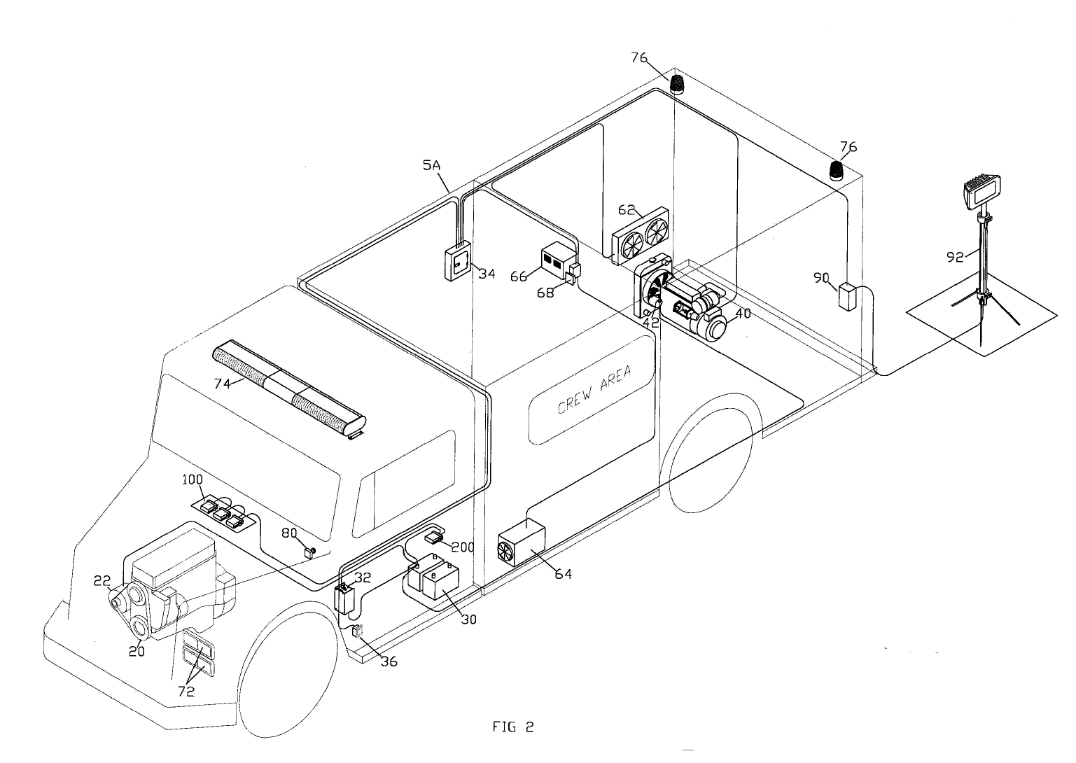

Specifically, as seen in FIG. 2, these embodiments of the invention provide a rescue vehicle idle reduction system, comprising: a rescue vehicle (ambulance 5A); an engine 20 in the rescue vehicle; a battery 30 in the rescue vehicle; an alternator 22 connected to the engine for changing the battery; a generator 40 in the rescue vehicle; an alternator 42 connected to generator 40 for charging battery 30. A ventilation system 60 and lighting system 70 are both powered by battery 30. A parking brake system 80 is also provided.

System 100A then (a) determines whether the parking brake is engaged; and (b) shuts off the engine and starts the generator when it is determined that the parking brake has been engaged for a pre-determined period of time. A safety system 200A (similar in operation to system 200 described above) can also be included.

As such, the present invention also includes the method of reducing idling time in a rescue vehicle, by: operating a rescue vehicle with an idle reduction system configured to: (a) determine if the parking brake on the rescue vehicle is engaged; and then (b) shut off the engine and start an on board generator to charge the rescue vehicle battery when the parking brake has been engaged for a predetermined period of time.

What is claimed:

1. A fire truck engine idle reduction system, comprising:
a fire truck;
an engine in the fire truck;
a battery in the fire truck;
an alternator connected to the engine for charging the battery;
a generator in the fire truck;
an alternator connected to the generator for charging the battery;
a water pumping system in the fire truck;
a ventilation system in the fire truck, the ventilation system being powered by the battery;
a lighting system in the fire truck, the lighting system being powered by the battery;
a parking brake system in the fire truck;
a system for determining whether the water pumping system is in pump mode;
a system for determining whether the parking brake is engaged; and
a system for shutting off the engine and starting the generator when the water pumping system is not in pump mode and the parking brake is engaged.

2. The idle reduction system of claim 1, wherein the ventilation system can be powered by a shoreline connection when the fire truck is parked in a fire station.

3. The idle reduction system of claim 1, further comprising:
a battery monitoring system for determining the strength of the battery; and
a system for restarting the engine to charge the battery if the strength of the battery drops below a pre-determined level.

4. The idle reduction system of claim 3, wherein the battery monitoring system is disposed in a programmable logic control system.

5. The idle reduction system of claim 1, wherein the parking brake must be engaged for a pre-determined period of time before the system for shutting off the engine and starting the generator shuts off the engine and starts the generator.

6. The idle reduction system of claim 5, wherein the predetermined period of time is about 5 minutes.

7. The idle reduction system of claim 1, further comprising:
an electrical outlet system on the fire truck, the electrical outlet system comprising outlets that are powered by the generator.

8. The idle reduction system of claim 1, wherein the engine and the generator share a main fuel reservoir.

9. The idle reduction system of claim 1, further comprising:
a shoreline power receiver mounted on the fire truck for receiving external power to charge the battery and power the ventilation systems.

10. A rescue vehicle idle reduction system, comprising:
a rescue vehicle;
an engine in the rescue vehicle;
a battery in the rescue vehicle;
an alternator connected to the generator for changing the battery;
a generator in the rescue vehicle;
an alternator connected to the generator for charging the battery;
a ventilation system in the rescue vehicle, the ventilation system being powered by the battery;
a lighting system in the rescue vehicle, the lighting system being powered by the battery;
a parking brake system in the rescue vehicle;
a system for determining whether the parking brake is engaged; and
a system for shutting off the engine and starting the generator when the parking brake is engaged.

11. The idle reduction system of claim 10, wherein the ventilation system can be powered by a shoreline connection when the rescue vehicle is parked in a station.

12. The idle reduction system of claim 10, further comprising:
a battery monitoring system for determining the strength of the battery; and
a system for restarting the engine to charge the battery if the strength of the battery drops below a pre-determined level.

13. The idle reduction system of claim 12, wherein the battery monitoring system is disposed in a programmable logic control system.

14. The idle reduction system of claim 12, wherein the parking brake must be engaged for a pre-determined period of time before the system for shutting off the engine and starting the generator shuts off the engine and starts the generator.

15. The idle reduction system of claim 12, wherein the engine and the generator share a main fuel reservoir.

16. A method of reducing fire truck engine idling, comprising:
operating a fire truck with an idle reduction system configured to:
(a) determine if a water pumping system on the fire truck is in pump mode;
(b) determine if the parking brake on the fire truck is engaged; and then
(c) shut off the engine and start an on board generator to charge the fire truck battery when the water pumping system is not in pump mode and the parking brake is engaged.

17. The method of claim 16, further comprising:
monitoring the strength of the battery; and
restarting the engine to charge the battery if the strength of the battery drops below a pre-determined level.

18. The method of claim 16, wherein the parking brake must be engaged for a pre-determined period of time before the system for shutting off the engine and starting the generator shuts off the engine and starts the generator.

19. A method of reducing idling time in a rescue vehicle, comprising:
operating a rescue vehicle with an idle reduction system configured to:
(a) determine if the parking brake on the rescue vehicle is engaged; and then
(b) shut off the engine and start an on board generator to charge the rescue vehicle battery when the parking brake has been engaged for a predetermined period of time.
